(19) United States
(12) Patent Application Publication
(10) Pub. No.: US 2024/0421874 A1
(43) Pub. Date: Dec. 19, 2024

(54) TECHNIQUES FOR SIGNALING TRANSITION BETWEEN TYPES OF CHANNEL STATE INFORMATION PROCESSING

(71) Applicant: QUALCOMM Incorporated, San Diego, CA (US)

(72) Inventors: Pavan Kumar VITTHALADEVUNI, San Diego, CA (US); Krishna Kiran MUKKAVILLI, San Diego, CA (US); Hung Dinh LY, San Diego, CA (US); Jay Kumar SUNDARARAJAN, San Diego, CA (US)

(21) Appl. No.: 18/334,848

(22) Filed: Jun. 14, 2023

(51) Int. Cl. H04B 7/06; H04W 24/02; H04W 72/23

(52) U.S. Cl. CPC H04B 7/0626; H04W 24/02; H04W 72/23

(57) ABSTRACT

Various aspects of the present disclosure generally relate to wireless communication. In some aspects, a user equipment (UE) may receive signaling indicating a transition from a first type of channel state information (CSI) processing to a second type of CSI processing at the UE, wherein at least one of the first type of CSI processing or the second type of CSI processing is a machine-learning-based CSI processing type. The UE may transition from the first type of CSI processing to the second type of CSI processing in accordance with the signaling and a timeline for the transition. Numerous other aspects are described.

### FIELD OF THE DISCLOSURE

Aspects of the present disclosure generally relate to wireless communication and to techniques and apparatuses for signaling a transition between types of channel state information processing.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving signaling indicating a transition from a first type of channel state information (CSI) processing to a second type of CSI processing at the UE, wherein at least one of the first type of CSI processing or the second type of CSI processing is a machine-learning-based CSI processing type. The method may include transitioning from the first type of CSI processing to the second type of CSI processing in accordance with the signaling and a timeline for the transition.

Some aspects described herein relate to a method of wireless communication performed by a network node. The method may include transmitting signaling indicating a transition from a first type of CSI processing to a second type of CSI processing at a UE, wherein at least one of the first type of CSI processing or the second type of CSI processing is a machine-learning-based CSI processing type. The method may include transitioning from the first type of CSI processing to the second type of CSI processing in accordance with the signaling and a timeline for the transition.

Some aspects described herein relate to a UE for wireless communication. The user equipment may include one or more memories and one or more processors coupled to the one or more memories. The one or more processors may be configured to receive signaling indicating a transition from a first type of CSI processing to a second type of CSI processing at the UE, wherein at least one of the first type of CSI processing or the second type of CSI processing is a machine-learning-based CSI processing type. The one or more processors may be configured to transition from the first type of CSI processing to the second type of CSI processing in accordance with the signaling and a timeline for the transition.

Some aspects described herein relate to a network node for wireless communication. The network node may include one or more memories and one or more processors coupled to the one or more memories. The one or more processors may be configured to transmit signaling indicating a transition from a first type of CSI processing to a second type of CSI processing at a UE, wherein at least one of the first type of CSI processing or the second type of CSI processing is a machine-learning-based CSI processing type. The one or more processors may be configured to transition from the first type of CSI processing to the second type of CSI processing in accordance with the signaling and a timeline for the transition.

Some aspects described herein relate to a non-transitory computer-readable medium that stores a set of instructions for wireless communication by a UE. The set of instructions, when executed by one or more processors of the UE, may cause the UE to receive signaling indicating a transition from a first type of CSI processing to a second type of CSI processing at the UE, wherein at least one of the first type of CSI processing or the second type of CSI processing is a machine-learning-based CSI processing type. The set of instructions, when executed by one or more processors of the UE, may cause the UE to transition from the first type of CSI processing to the second type of CSI processing in accordance with the signaling and a timeline for the transition.

Some aspects described herein relate to a non-transitory computer-readable medium that stores a set of instructions for wireless communication by a network node. The set of instructions, when executed by one or more processors of the network node, may cause the network node to transmit signaling indicating a transition from a first type of CSI processing to a second type of CSI processing at a UE, wherein at least one of the first type of CSI processing or the second type of CSI processing is a machine-learning-based CSI processing type. The set of instructions, when executed by one or more processors of the network node, may cause the network node to transition from the first type of CSI processing to the second type of CSI processing in accordance with the signaling and a timeline for the transition.

Some aspects described herein relate to an apparatus for wireless communication. The apparatus may include means for receiving signaling indicating a transition from a first type of CSI processing to a second type of CSI processing at the apparatus, wherein at least one of the first type of CSI processing or the second type of CSI processing is a machine-learning-based CSI processing type. The apparatus may include means for transitioning from the first type of CSI processing to the second type of CSI processing in accordance with the signaling and a timeline for the transition.

Some aspects described herein relate to an apparatus for wireless communication. The apparatus may include means for transmitting signaling indicating a transition from a first type of CSI processing to a second type of CSI processing at a UE, wherein at least one of the first type of CSI processing or the second type of CSI processing is a machine-learning-based CSI processing type. The apparatus may include means for transitioning from the first type of CSI processing to the second type of CSI processing in accordance with the signaling and a timeline for the transition.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of determination of Type-III channel state information (CSI) feedback determination and processing, in accordance with the present disclosure.

FIG. 5 is a diagram illustrating an example of machine-learning-based CSI feedback using transmitter-side and receiver-side neural networks, in accordance with the present disclosure.

FIG. 6 is a diagram illustrating an example of signaling associated with switching CSI processing types between a machine-learning-based CSI processing type and a non-machine-learning-based CSI processing type, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In a wireless communication system, a transmitter (such as a user equipment (UE)) may provide channel state information (CSI) regarding a channel between the transmitter and a receiver (such as a network node). The CSI may be derived from CSI reference signals (CSI-RSs) transmitted by the receiver, such that the receiver can use the CSI to determine parameters for communication between the transmitter and the receiver in view of a condition of the channel. Operations used to generate CSI may be referred to herein as CSI processing.

There are various types of CSI processing. Some types of CSI processing may involve encoding and/or determination of CSI using a machine learning (ML) based model, such as a neural network (e.g., an artificial neural network). For example, a transmitter may input information (e.g., CSI, raw channel information, or similar information) to an encoding model (e.g., an artificial neural network). The encoding model may output a payload, such as CSI or compressed CSI. The transmitter may transmit the payload to a receiver. The receiver may use a decoding model (e.g., an artificial neural network) to decode the payload, which enables the transmitter to obtain the CSI, the raw channel information, or information derived from the CSI or the raw channel information. Neural network processing of CSI may reduce the payload size or enrich the CSI provided from the transmitter to the receiver. There are also types of non-ML-based CSI processing, such as Type-I CSI processing, Type-II CSI processing, or eType-II CSI processing, described elsewhere herein.

It may be beneficial for a UE to switch between different types of CSI processing. For example, the UE may switch from an ML-based CSI processing type to a non-ML-based CSI processing type to reduce power consumption or processor load. As another example, the UE may switch from a non-ML-based CSI processing type to an ML-based CSI processing type to improve richness of the CSI or reduce a payload size. Furthermore, in some situations, a network node may switch between different types of CSI processing. However, if the network node is unaware of the type of CSI processing used by the UE (or vice versa), CSI feedback may fail, leading to inefficient communications between the UE and the network node. Furthermore, in some cases, the network node may change network energy saving (NES) state, leading to an inability to efficiently process certain forms of CSI (for example, generated using an ML-based CSI processing type). Still further, without a common understanding of when a UE is to switch CSI processing types, miscommunication may occur, leading to unsuccessful processing of CSI feedback received from the UE.

Various aspects relate generally to CSI feedback. Some aspects more specifically relate to signaling to change a type of CSI processing. In some examples, a UE may receive signaling indicating a transition from a first type of CSI processing to a second type of CSI processing. The UE may transition from the first type of CSI processing to the second type of CSI processing in accordance with the signaling and in accordance with a timeline. In some aspects, the UE may request the second type of CSI processing. In some aspects, the transition (or the signaling indicating the transition) may be based at least in part on a change in NES state of the network node.

Particular aspects of the subject matter described in this disclosure can be implemented to realize one or more of the following potential advantages. In some examples, by transitioning to the second type of CSI processing in accordance with the timeline, the described techniques can be used to improve common understanding of when the UE is to switch CSI processing types, thereby reducing the occurrence of unsuccessful processing of CSI. By requesting the second type of CSI processing, the UE can provide information regarding a preferred type of CSI processing, which may enable the UE to reduce power consumption or increase richness of CSI feedback based on conditions at the UE. By performing (or triggering) the transition based at least in part on the change in the NES state, the network node can adjust complexity of CSI processing (such as by activating or deactivating ML-based CSI processing), thereby reducing complexity of CSI processing in lower NES states (corresponding to lower energy consumption) and improving richness or compression of CSI feedback in higher NES states (corresponding to higher energy consumption).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

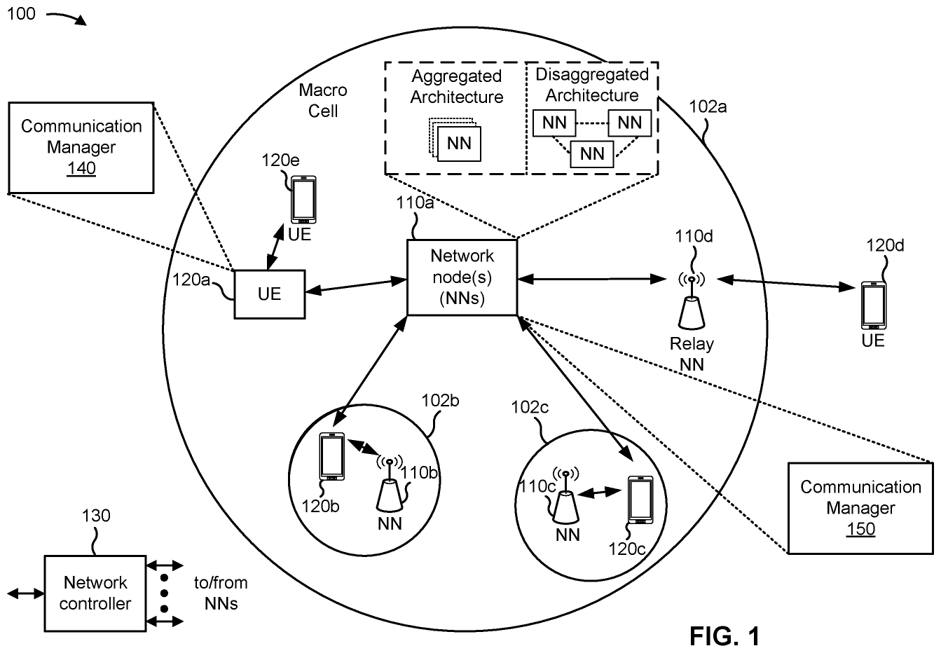

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive signaling indicating a transition from a first type of CSI processing to a second type of CSI processing at the UE, wherein at least one of the first type of CSI processing or the second type of CSI processing is a machine-learning-based CSI processing type; and transition from the first type of CSI processing to the second type of CSI processing in accordance with the signaling and a timeline for the transition. Additionally, or alternatively, the communication manager 140 may perform one or more other operations described herein.

In some aspects, the network node 110 may include a communication manager 150. As described in more detail elsewhere herein, the communication manager 150 may transmit signaling indicating a transition from a first type of CSI processing to a second type of CSI processing at a UE, wherein at least one of the first type of CSI processing or the second type of CSI processing is a machine-learning-based CSI processing type; and transition from the first type of CSI processing to the second type of CSI processing in accordance with the signaling and a timeline for the transition. Additionally, or alternatively, the communication manager 150 may perform one or more other operations described herein.

As indicated above, FIG. 1 is provided as an example. Other examples may differ from what is described with regard to FIG. 1.

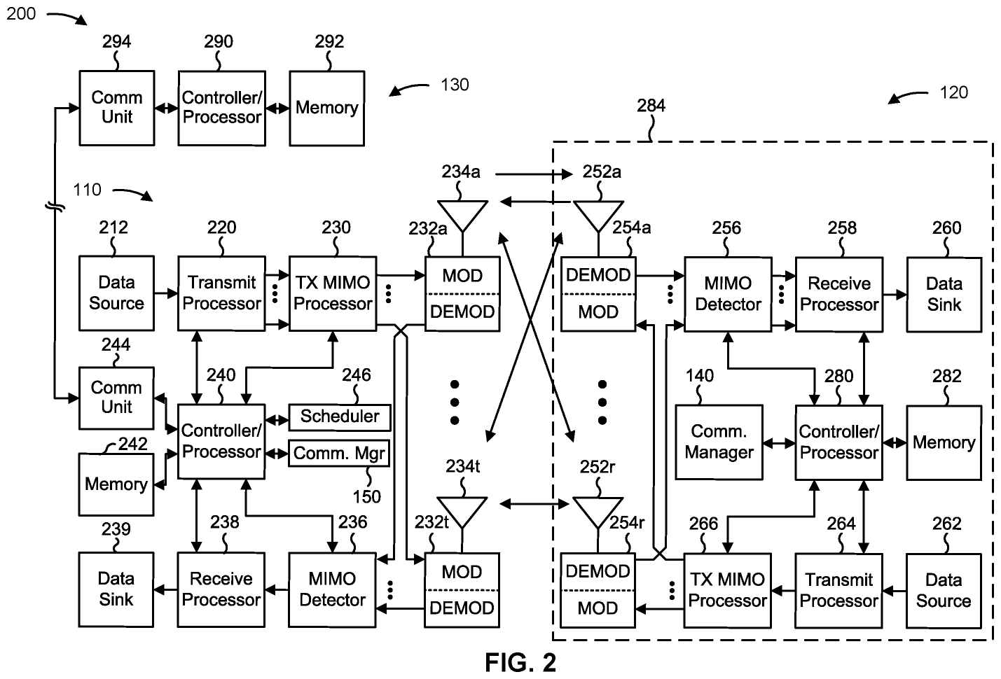

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

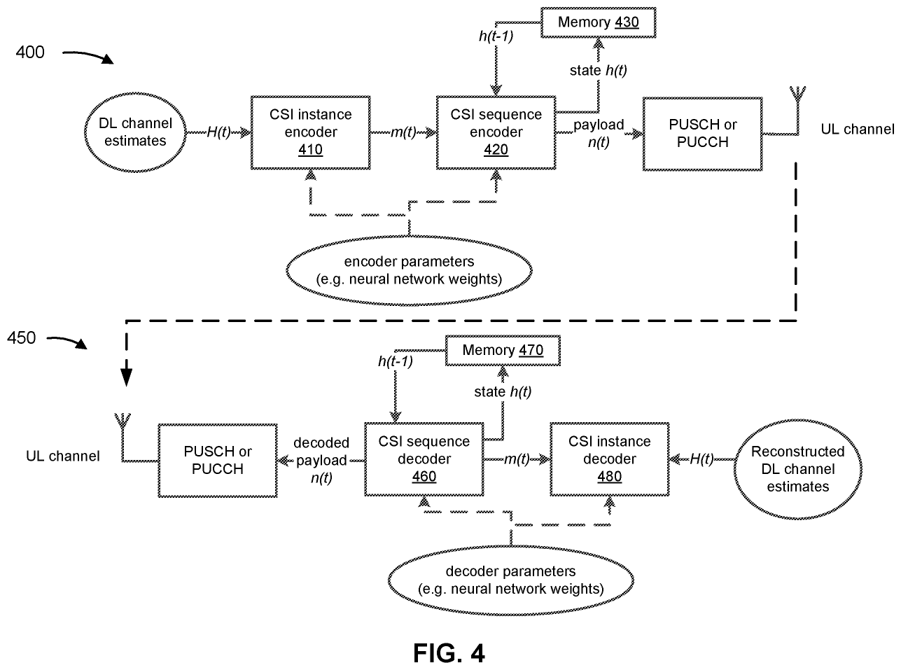

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver May be used by a processor (for example, the controller/processor 240) and the memory 242 to perform aspects of any of the processes described herein (e.g., with reference to FIGS. 4-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

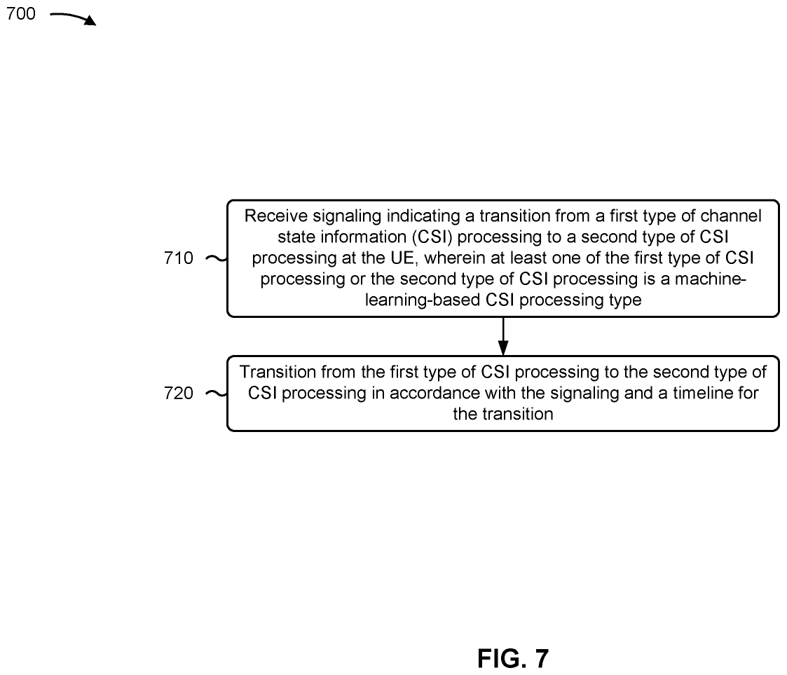

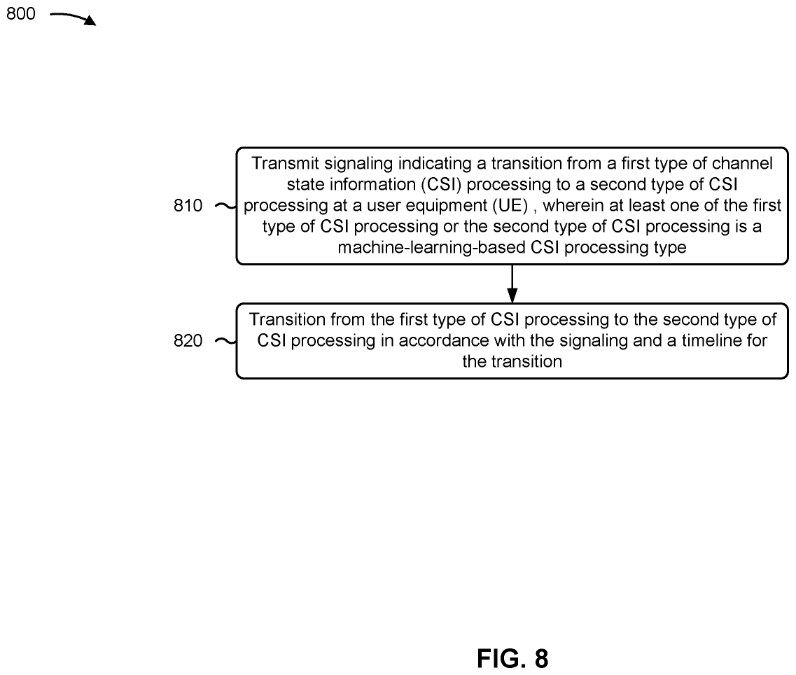

The controller/processor 240 of the network node 110, the controller/processor 280 of the UE 120, or any other component(s) of FIG. 2 may perform one or more techniques associated with CSI feedback, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving signaling indicating a transition from a first type of CSI processing to a second type of CSI processing at the UE, wherein at least one of the first type of CSI processing or the second type of CSI processing is a machine-learning-based CSI processing type; and/or means for transitioning from the first type of CSI processing to the second type of CSI processing in accordance with the signaling and a timeline for the transition. The means for the user equipment UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting signaling indicating a transition from a first type of CSI processing to a second type of CSI processing at a UE, wherein at least one of the first type of CSI processing or the second type of CSI processing is a machine-learning-based CSI processing type; and/or means for transitioning from the first type of CSI processing to the second type of CSI processing in accordance with the signaling and a timeline for the transition. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

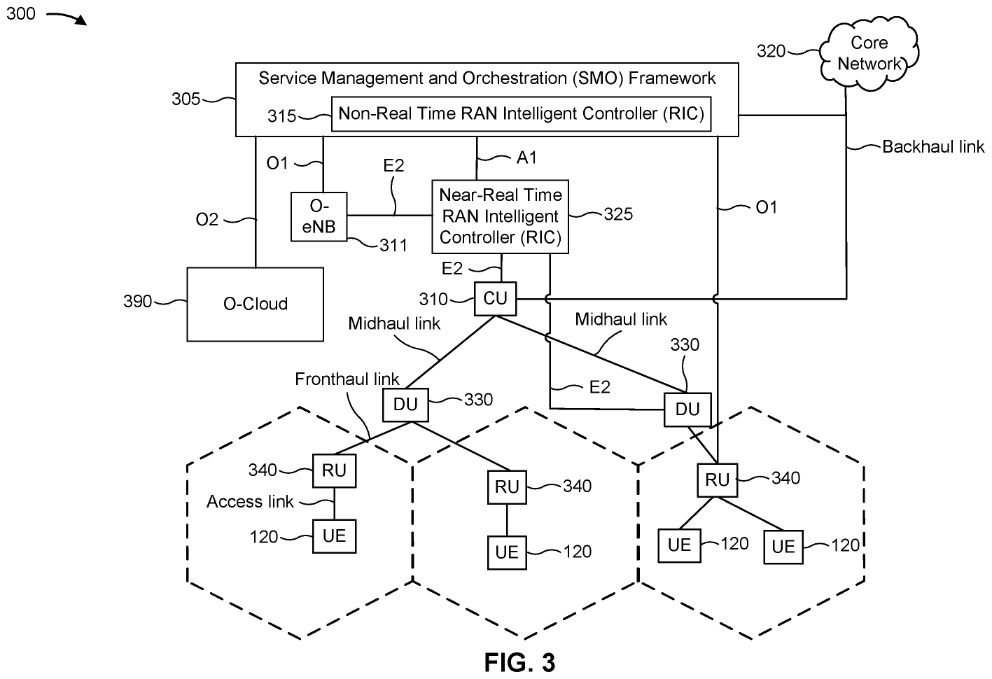

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A UE 120 may measure CSI-RSs and transmit a CSI report that indicates CSI that is determined based at least in part on the CSI-RSs. The CSI provides information regarding a channel such that a network node 110 can manage the connection between the network node 110 and the UE 120. In general, a channel may be represented by a channel matrix (generally represented by the variable H). The channel matrix may, for instance, represent a channel in the time domain (generally referred to as a channel impulse response) or in the frequency domain (generally referred to as a channel frequency response) or a combination thereof. Further representations, such as in the delay Doppler domain, can also be used. In the present disclosure, “channel information” (in contrast to “channel state information”) refers to an uncompressed (e.g., raw or unprocessed) characterization or representation or state of a channel, such as the above mentioned representations by a channel matrix. The channel information may further refer to information derived from the raw channel without loss of dimensionality/dimension reduction. As a consequence, the channel information may comprise sufficient information to allow deriving the channel matrix from the channel information without loss of accuracy. In this context, it is noted that the channel matrix itself may not be perfectly known, but merely estimated. Furthermore, a rank of the channel matrix may not be full (e.g., due to correlation between the transmit-receive paths). For frequency domain compression, the channel information may be based on a channel frequency response. In other words, the channel matrix may represent the channel in the frequency domain.

In time-division duplex (TDD) systems, channels in the uplink (UL) and downlink (DL) directions are the same, hence, a transmitter (e.g., a gNB) can deduce the (e.g., DL) CSI from respective (e.g., UL) pilots. This deduction is sometimes referred to as implicit feedback. In frequency-division duplex (FDD) systems, however, explicit feedback is generally required as reciprocity between UL and DL channels cannot be guaranteed. For DL CSI, for instance, the UE may measure CSI-RSs and transmit a CSI report that indicates CSI to the transmitter (e.g., a gNB).

CSI included in a CSI report may comprise processed channel information which reduces the amount of UL data involved in the CSI feedback compared to feedback of the complete channel information. Such feedback of processed channel information is sometimes referred to as implicit CSI feedback and is, for instance, broadly used in LTE systems where it can give a satisfactory performance.

For example, in some systems (such as systems utilizing beamformed communication) the CSI may indicate a set of beams selected by the UE 120, or may include information that facilitates the selection of beams or communication parameters by the network node 110. The information included in a CSI report, which may be referred to as CSI or channel state feedback, may include a CQI, a rank indicator (RI), a W₁ codebook payload, and/or a precoding matrix indicator (PMI), among other examples described elsewhere herein. The CQI may indicate downlink radio conditions for a bandwidth part, such as in terms of a signal-to-interference-plus-noise ratio (SINR). The RI may indicate a requested number of MIMO layers for the UE 120. A W₁ codebook payload may indicate a selected set of L beams from an oversampled codebook, and may further indicate a subspace defined by L beams per polarization.

NR Type-II codebook CSI may offer gain over LTE codebooks, at the cost of an increase in UL overhead. In order to reap the benefits of an increased number of antenna ports, advanced precoding schemes such as non-linear precoding or multi-TRP transmission may be used. Highly accurate CSI feedback may facilitate such schemes. In other words, so-called explicit CSI feedback may be desirable which may allow deriving the original channel matrix (as measured, determined, or estimated at the UE) from the CSI feedback with little or no loss of information. In an ideal scenario, the complete channel information (e.g., channel matrix) would be fed back by the UE.

Explicit CSI feedback may be associated with significant overhead. For example, sub-band information, which may be provided as part of a Type-II codebook, described below, may have a large payload. The large size and complexity of (e.g., explicit) CSI in view of limited UL channel capacity may limit the implementation of more complex forms of CSI, thereby limiting gains in feedback reporting and usage. Furthermore, the transmission of large CSI may use significant UE and network resources.

In some aspects, CSI feedback may include enhanced Type-II (eType-II) CSI feedback. The CSI report may include a codebook, which is a set of precoders or one or more PMIs. A Type-I codebook may include predefined matrices. A Type-II codebook may include a more detailed CSI report for multi-user MIMO and may include a group of beams. In some cases, the Type II CSI feedback may use a compressed Type II precoder. This may reduce overhead of Type II CSI feedback. The compressed precoder may exploit the sparsity of the spatial domain and/or the frequency domain. Procedures for eType-II CSI feedback, including the eType-II CSI codebook, compression methods, and reporting, are defined in Release 17 of 3GPP Technical Specification (TS) 38.214, such as at Sections 5.2.2.2.5 and 5.2.2.2.6. eType-II CSI feedback may include a matrix (W_{f}) containing one or more frequency-domain bases derived from channel information. For example, Type-I CSI feedback may provide a set of CSI parameters including CQI, RI, and a PMI. Type-II CSI feedback may, in addition to or as an alternative to CQI, RI, and/or PMI, provide a W₁ codebook payload indicating a selected set of L beams from an oversampled codebook, and may further indicate a subspace defined by L beams per polarization. eType-II CSI may include CQI, RI, a PMI, a W₁ codebook, and a W_{f} matrix. In addition to the CQI, RI, a PMI, a W₁ codebook, and the W_{f} matrix, Doppler CSI may include a Wₜ matrix derived from Doppler parameters of the channel. In some aspects, CSI feedback may indicate a raw channel. In some other aspects, CSI feedback may include a set of singular value decomposition (SVD) beams derived from the raw channel. Thus, Type-I CSI is a beam selection scheme, in which the UE selects beam indices and transmits CSI feedback based at least in part on beam indices. Type-II CSI is a beam-combination scheme, in which the UE computes linear combination coefficients of various beams, and transmits CSI feedback indicating the beam indices and the linear combination coefficients, on a sub-band basis. Type-I CSI, Type-II CSI, and eType-II CSI may be referred to as non-machine-learning-based CSI feedback. A CSI processing type of a CSI processing scheme used to generate Type-I CSI may be referred to as a non-machine-learning-based CSI processing type. A CSI processing type of a CSI processing scheme used to generate Type-II CSI may be referred to as a non-machine-learning-based CSI processing type. A CSI processing type of a CSI processing scheme used to generate eType-II CSI may be referred to as a non-machine-learning-based CSI processing type.

FIG. 4 is a diagram illustrating an example 400 of determination of Type-III CSI feedback determination and processing, in accordance with the present disclosure. “Type-III CSI feedback” may refer to machine-learning-based CSI feedback, and may be determined using a CSI processing scheme having a machine-learning-based CSI processing type. For example, Type-III CSI feedback may include a CSI payload (e.g., CSI, or feedback derived from CSI) that is generated using a machine-learning-based model, such as a neural network. FIG. 4 shows an encoding device 400 (e.g., UE 120) with a CSI instance encoder 410, a CSI sequence encoder 420, and a memory 430. FIG. 4 also shows a decoding device 450 (e.g., network node 110) with a CSI sequence decoder 460, a memory 470, and a CSI instance decoder 480.

As shown in FIG. 4, CSI instance encoder 410 may encode a CSI instance into intermediate encoded CSI for each DL channel estimate in a sequence of DL channel estimates. CSI instance encoder 410 (e.g., a feedforward network) may use neural network encoder weights θ. The intermediate encoded CSI may be represented as m(t)≙f_{enc,θ}(H(t)). CSI sequence encoder 420 (e.g., a Long Short-Term Memory (LSTM) network) may determine a previously encoded CSI instance h(t−1) from memory 430 and compare the intermediate encoded CSI m(t) and the previously encoded CSI instance h(t−1) to determine a change n(t) in the encoded CSI. The change n(t) may be a part of a channel estimate that is new and may not be predicted by the decoding device 450. The encoded CSI at this point may be represented by [n(t), h_{enc}(t)]¬g_{enc,θ}(m(t), h_{enc}(t−1)). CSI sequence encoder 420 may provide this change n(t) on the physical uplink shared channel (PUSCH) or the physical uplink control channel (PUCCH), and the encoding device 400 may transmit the change (e.g., information indicating the change) n(t) as the encoded CSI on the UL channel to the decoding device 450. Because the change is smaller than an entire CSI instance, the encoding device 400 may send a smaller payload for the encoded CSI on the UL channel, while including more detailed information in the encoded CSI for the change. CSI sequence encoder 420 may generate encoded CSI h(t) based at least in part on the intermediate encoded CSI m(t) and at least a portion of the previously encoded CSI instance h (t−1). CSI sequence encoder 420 may save the encoded CSI h(t) in memory 430.

CSI sequence decoder 460 may receive encoded CSI on the PUSCH or PUCCH. CSI sequence decoder 460 may determine that only the change n(t) of CSI is received as the encoded CSI. CSI sequence decoder 460 may determine an intermediate decoded CSI m(t) based at least in part on the encoded CSI and at least a portion of a previous intermediate decoded CSI instance h (t−1) from memory 470 and the change. CSI instance decoder 480 may decode the intermediate decoded CSI m(t) into decoded CSI. CSI sequence decoder 460 and CSI instance decoder 480 may use neural network decoder weights ¢. The intermediate decoded CSI may be represented by [\hat{m}(t), h_{dec}(t)]≙g_{dec,ϕ}(n(t), h_{dec}(t−1)). CSI sequence decoder 460 may generate decoded CSI h(t) based at least in part on the intermediate decoded CSI m(t) and at least a portion of the previously decoded CSI instance h(t−1). The decoding device 450 may reconstruct a DL channel estimate from the decoded CSI h(t), and the reconstructed channel estimate may be represented as H\hat{ }(t)≙f_(dec, ϕ) (m\hat{ }(t)). CSI sequence decoder 460 may save the decoded CSI h(t) in memory 470.

Because the change n(t) is smaller than an entire CSI instance, the encoding device 400 may send a smaller payload on the UL channel. For example, if the DL channel has changed little from previous feedback, due to a low Doppler or little movement by the encoding device 400, an output of the CSI sequence encoder may be rather compact. In this way, the encoding device 400 may take advantage of a correlation of channel estimates over time. In some aspects, because the output is small, the encoding device 400 may include more detailed information in the encoded CSI for the change. In some aspects, the encoding device 400 may transmit an indication (e.g., flag) to the decoding device 450 that the encoded CSI is temporally encoded (a CSI change). Alternatively, the encoding device 400 may transmit an indication that the encoded CSI is encoded independently of any previously encoded CSI feedback. The decoding device 450 may decode the encoded CSI without using a previously decoded CSI instance. In some aspects, a device, which may include the encoding device 400 or the decoding device 450, may train a neural network model using a CSI sequence encoder and a CSI sequence decoder.

In some aspects, a reconstructed DL channel Ĥ may faithfully reflect the DL channel H, and this may be called explicit feedback. In some aspects, Ĥ may capture only that information used (e.g., required) for the decoding device 450 to derive rank and precoding. CQI may be fed back separately. CSI feedback may be expressed as m(t), or as n(t) in a scenario of temporal encoding. Similarly to Type-II CSI feedback, m(t) may be structured to be a concatenation of rank indicator (RI), beam indices, and coefficients representing amplitudes or phases. In some aspects, m(t) may be a quantized version of a real-valued vector. Beams may be pre-defined (not obtained by training), or may be a part of the training (e.g., part of θ and ϕ and conveyed to the encoding device 400 or the decoding device 450).

In some aspects, the decoding device 450 and the encoding device 400 may maintain multiple encoder and decoder networks, each targeting a different payload size (for varying accuracy vs. UL overhead tradeoff). For each CSI feedback, depending on a reconstruction quality and an uplink budget (e.g., PUSCH payload size), the encoding device 400 may choose, or the decoding device 450 may instruct the encoding device 400 to choose, one of the encoders to construct the encoded CSI. The encoding device 400 may send an index of the encoder along with the CSI based at least in part on an encoder chosen by the encoding device 400. Similarly, the decoding device 450 and the encoding device 400 may maintain multiple encoder and decoder networks to cope with different antenna geometries and channel conditions. Note that while some operations are described as being performed by the decoding device 450 and/or the encoding device 400, these operations may also be performed by another device, as part of a preconfiguration of encoder and decoder weights and/or structures.

While the description of FIG. 4 includes incremental CSI encoding and decoding, machine-learning-based CSI feedback (e.g., Type-III CSI) may include other forms of CSI determined using an ML-based model, such as CSI encoding and decoding that is performed in a non-incremental fashion.

As indicated above, FIG. 4 may be provided as an example. Other examples may differ from what is described with regard to FIG. 4.

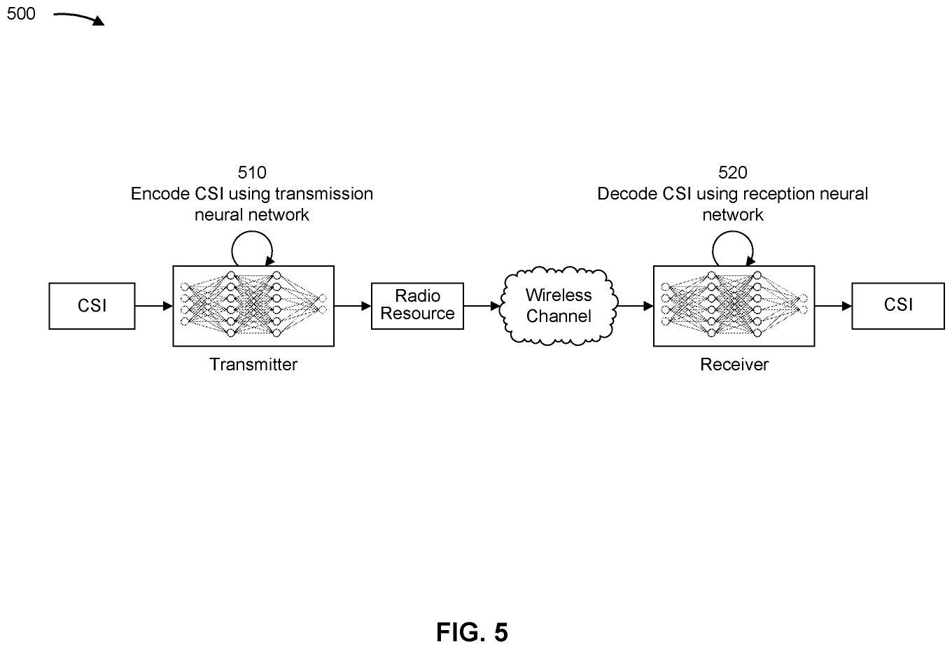

FIG. 5 is a diagram illustrating an example 500 of machine-learning-based CSI feedback using transmitter-side and receiver-side neural networks, in accordance with various aspects of the present disclosure. In some aspects, the CSI transmission and reception shown in FIG. 5 may be performed between a transmitter and a receiver in a wireless network. For example, in some aspects, the receiver may be a network node 110 and the transmitter may be a UE 120. Additionally, or alternatively, the transmitter may be a first UE and the receiver may be a second UE, in which case the first UE may provide encoded CSI to the second UE over a sidelink.

Machine-learning-based CSI feedback may provide for generation of encoded CSI using an ML-based CSI processing type, and transmission of the encoded CSI using a transmit-receive (Tx-Rx) design in which AI techniques use one or more neural networks in an encoder (e.g., an autoencoder) and a decoder to enable CSI transmission. For example, as shown by reference number 510, the transmitter may provide CSI (such as one or more parameters of CSI, raw channel information, a processed channel, channel state feedback, or the like) to a transmission neural network that encodes the CSI to form machine-learning-based CSI feedback. As further shown by reference number 520, the receiver may decode the machine-learning-based CSI using a reception neural network in order to obtain CSI or other parameters regarding the channel between the transmitter and the receiver.

In some aspects, the transmission neural network and the reception neural network may be jointly trained (e.g., offline using CSI samples). In this way, the joint Tx-Rx design using a transmission neural network at the transmitter and a reception neural network at the receiver may provide data-driven robustness based on channel models, in that autoencoders may not require knowledge of the underlying data distribution of the input or an explicit identification of a structure of the input. For example, CSI feedback in MIMO FDD systems is typically associated with significant overhead and relates to sparse channels, which leads to significant compression gains using a neural network-based encoder/decoder.

As indicated above, FIG. 5 is provided as an example. Other examples may differ from what is described with regard to FIG. 5.

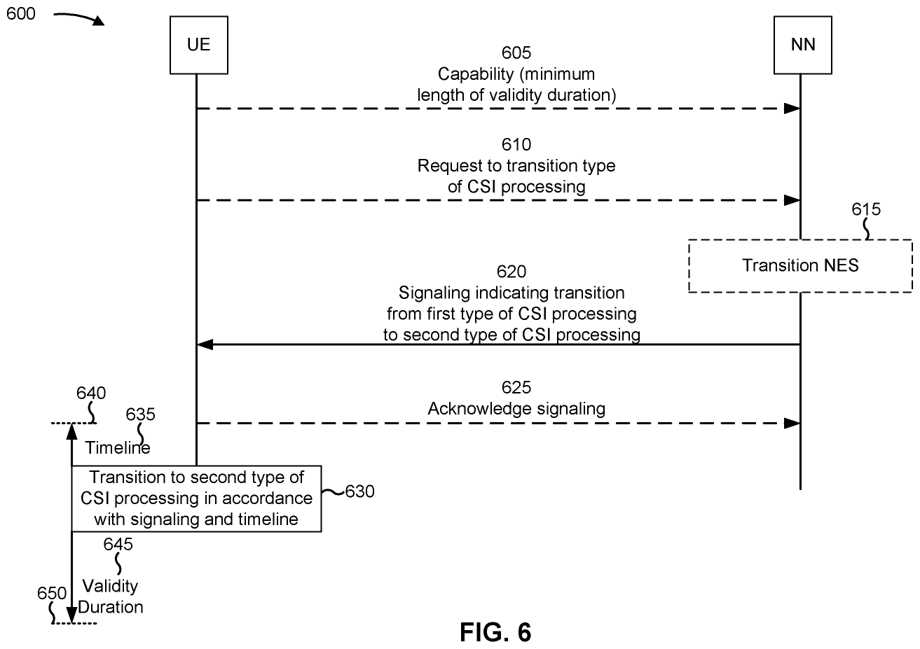

FIG. 6 is a diagram illustrating an example 600 of signaling associated with switching CSI processing types between a machine-learning-based CSI processing type and a non-machine-learning-based CSI processing type, in accordance with the present disclosure. Example 600 includes a UE (e.g., UE 120, the transmitter of FIG. 5, the encoder device 400 of FIG. 4) and a network node (e.g., network node 110, the receiver of FIG. 5, the decoder device 450 of FIG. 4). FIG. 6 generally relates to transitioning from a first type of CSI processing to a second type of CSI processing. At least one of the first type of CSI processing or the second type of CSI processing may be a machine-learning based CSI processing type, as described with regard to FIGS. 4 and 5. The first type of CSI processing may be selected from one or more machine-learning based CSI processing types and/or one or more non-machine-learning based CSI processing types, which are described with regard to FIGS. 4 and 5. The second type of CSI processing may be selected from one or more machine-learning based CSI processing types and/or one or more non-machine-learning based CSI processing types, which are described with regard to FIGS. 4 and 5. In some aspects, the first type of CSI processing may be a first machine-learning based CSI processing type, and the second type of CSI processing may be a second machine-learning based CSI processing type.

As shown by reference number 605, in some aspects, the UE may transmit, and the network node may receive, capability information including one or more capabilities. In some aspects, a capability of the capability information may indicate a minimum length of a validity duration. A validity duration is described in more detail below.

As shown by reference number 610, in some aspects, the UE may transmit a request to transition a type of CSI processing (e.g., from a first type of CSI processing to a second type of CSI processing). In some aspects, the request may be based at least in part on a condition at the UE, such as an available UE power, a service type of a communication of the UE (e.g., eMBB versus ultra-reliable low-latency communication), or the like. In some aspects, the request may indicate the second type of CSI processing. Additionally, or alternatively, the request may indicate to transition to any machine-learning-based CSI processing type. In some other aspects, the request may indicate to transition away from the first type of CSI processing (e.g., without specifying the second type of CSI processing). In some aspects, the request May include at least one of a PRACH transmission, a PUCCH transmission, a PUSCH transmission, or a dedicated physical channel transmission. The dedicated physical channel transmission may use a specific sequence corresponding to the request to transition.

In some aspects, the request may include a PRACH transmission on a particular resource or occasion, such as a dedicated PRACH resource occasion reserved for the request. In some aspects, the request may include a PRACH transmission using a particular PRACH preamble. For example, a PRACH resource occasion for the request may be shared with other use cases (e.g., beam failure recovery, link failure recovery, initial access), and a dedicated set of PRACH preambles may be reserved for the request to transition.

As shown by reference number 615, in some aspects, the network node may transition a NES state. An NES state may indicate a set of configurations or parameters at the network node that relate to network energy savings. For example, a first NES state may indicate a full transmit power, a full decoding configuration, a full reference signaling configuration, or the like. A second NES state may indicate a decreased transmit power, a decreased (or deactivated) decoding configuration, a decreased (or deactivated) reference signaling configuration, or the like. For example, a first configuration state (e.g., an active configuration state) may be associated with (e.g., used while the network node is in) the first NES state, and a second configuration state (e.g., an inactive configuration state or an idle configuration state) may be associated with (e.g., used while the network node is in) the second NES state. In some aspects, an NES state may indicate a type of CSI processing used by the network node. For example, a first NES state may use machine-learning-based CSI processing, and a second NES state may use non-machine-learning-based CSI processing.

As shown by reference number 620, the network node may transmit, and the UE may receive, signaling indicating a transition from a first type of CSI processing to a second type of CSI processing. In some aspects, the signaling may indicate the second type of CSI processing (e.g., and may not indicate the first type of CSI processing). In some aspects, the signaling may indicate to switch from a non-machine-learning-based CSI processing type (such as may be used to determine Type-I, Type-II, or eType-II CSI feedback) to a machine-learning-based CSI processing type (such as may be used to determine Type-III CSI feedback), or from a machine-learning-based CSI processing type to a non-machine-learning-based CSI processing type. In some aspects, the signaling may indicate to switch from a first machine-learning-based CSI processing type to a second machine-learning-based CSI processing type, such as using a different ML model than the first CSI processing type. In some aspects, the signaling may be based at least in part on the request shown by reference number 610. For example, the network node may transmit the signaling in response to the request, or the signaling may indicate a type of CSI processing indicated by the request. In some aspects, the signaling may be based at least in part on a transition of an NES state. For example, the network node may transmit signaling indicating for the UE to transition to a type of CSI processing that is supported by the network node after switching to an NES state that uses the type of CSI processing supported by the network node. In some aspects, the signaling may comprise MAC layer signaling, such as a MAC control element (MAC-CE) based indication.

In some aspects, the signaling may include downlink control information (DCI) including a field indicating the transition. For example, the DCI may include a switching indication field. The DCI may include group-specific DCI or UE-specific DCI. In some aspects, the DCI may include DCI for paging. In some aspects, the DCI may include group-specific DCI that is specific to indicating the transition. For example, the group-specific DCI may be specific to signaling indicating the transition. In this example, the UE may monitor a physical downlink control channel (PDCCH) for the group-specific DCI that is specific to signaling indicating the transition (e.g., using blind decoding hypotheses corresponding to the group-specific DCI).

In some aspects, the signaling may include a physical downlink shared channel (PDSCH) transmission containing a paging message. For example, the network node may transmit the PDSCH transmission containing the paging message in a group manner.

As shown by reference number 625, in some aspects, the UE may transmit an acknowledgment of the signaling. For example, the UE may transmit hybrid automatic repeat request (HARQ) acknowledgment (HARQ-ACK) information to confirm that the signaling was received. In some aspects, the UE may transmit the HARQ-ACK feedback when the signaling includes DCI. In some aspects, the acknowledgment is not needed when the signaling is provided via a MAC-CE since the UE may always transmit HARQ-ACK information in response to successful reception of PDSCH carrying a MAC-CE. Also, if the indication is provided via UE group DCI, the UE may not need to send the confirmation (since there may be many HARQ-ACK transmission from UEs and the DCI may carry have uplink resource assignment for the feedback). In some aspects, an uplink resource for the feedback may be pre-reconfigured for the UE to transmit the acknowledgment. For example, the network node may transmit, and the UE may receive, information indicating the uplink resource, such as an RRC configuration indicating the resource.

As shown by reference number 630, the UE may transition to the second type of CSI processing in accordance with the signaling and in accordance with a timeline. For example, the UE may cease generating CSI using the first type of CSI processing, and may start generating CSI using the second type of CSI processing. The timeline is shown by reference number 635. The timeline may indicate a length of time. A starting time of the length of time is shown by reference number 640. The starting time is not illustrated in an exact fashion, so the exact starting time of the length of time may not be configured as shown in FIG. 6.

In some aspects, the timeline indicates a length of time between reception of the signaling and the transition. In such examples, the reception of the signaling shown by reference number 620 may comprise the starting time of the length of time.

In some aspects, the length of time includes a number of symbols after a last symbol of a channel for transmission of an acknowledgement (such as the acknowledgment shown by reference number 625) of the signaling. For example, if the signaling includes a MAC-CE, the second type of CSI processing may be applied X symbols after the last symbol of a PUCCH or PUSCH in which the UE transmits an acknowledgment (e.g., HARQ-ACK information) in response to successful reception of a PDSCH carrying the MAC-CE. As another example, if the signaling includes DCI, the second type of CSI processing may be applied X symbols after the last symbol of a PUCCH or a PUSCH in which the UE transmits an acknowledgment (e.g., HARQ-ACK information) in response to successful reception of a PDCCH communication carrying the DCI. In such examples, the last symbol of the channel may comprise the starting time of the length of time.

In some aspects, the length of time is based at least in part on a subcarrier spacing, wherein the subcarrier spacing is based at least in part on at least one of a subcarrier spacing of a downlink bandwidth part on which the signaling is received, a subcarrier spacing of an uplink bandwidth part associated with an acknowledgement of the signaling, or a specified subcarrier spacing value. For example, if the signaling includes a MAC-CE, the subcarrier spacing to determine a symbol duration of the length of time may be the subcarrier spacing of the active downlink bandwidth part over which a PDSCH communication carrying the MAC-CE is received, the subcarrier spacing of the active uplink bandwidth part over which a PUCCH communication or PUSCH communication is transmitted, or may be fixed in a wireless communication specification. As another example, if the signaling includes DCI, the subcarrier spacing to determine a symbol duration of the length of time may be the subcarrier spacing of the active downlink bandwidth part over which the PDCCH communication is received, the subcarrier spacing of the active uplink bandwidth part over which the UE transmits a PUCCH communication or a PUSCH communication, or may be fixed in a wireless communication specification.

In some aspects, the length of time comprises a number of symbols after a last symbol of a control resource set (CORESET) in which the signaling is received. For example, if the signaling includes DCI, the second type of CSI processing may be applied X symbols after the last CORESET symbol where the DCI containing the indication is received. In this example, the length of time may be based at least in part on a subcarrier spacing, wherein the subcarrier spacing is based at least in part on at least one of a subcarrier spacing of a downlink bandwidth part on which the signaling is received, or a specified subcarrier spacing value. For example, the subcarrier spacing to determine a symbol duration of the length of time can be the subcarrier spacing of the UE's active downlink bandwidth part (containing the CORESET over which the UE monitors PDCCH for the indication), or may be fixed in a wireless communication specification.

In some aspects, the UE may transition to the second type of CSI processing in accordance with a validity duration. The validity duration is shown by reference number 645, and ends at an end time shown by reference number 650. In some aspects, the validity duration may start upon the UE transitioning to the second type of CSI processing. A validity duration may indicate a length of time during which the UE uses the second type of CSI processing (e.g., before switching back to the first type of CSI processing or to a third type of CSI processing). Transitioning to the second type of CSI processing in accordance with the validity duration may include using the second type of CSI processing until at least the end time shown by reference number 650. In some aspects, the validity duration starts upon occurrence of the transitioning from the first type of CSI processing to the second type of CSI processing, such as at reference number 630. In some aspects, the validity duration may be in accordance with a capability transmitted by the UE, such as at reference number 605. Thus, the UE may reduce the occurrence of frequent switching between types of CSI processing, which may prevent a situation in which CSI processing switches occur more frequently than the UE is capable of handling (e.g., in back-to-back slots).

In some aspects, the UE may use the second type of CSI processing until a cancellation, or an indication to transition to a third type of CSI processing, is received. For example, the network node may transmit an indication to cancel the second type of CSI processing. As another example, the network node may transmit an indication to transition to a third type of CSI processing.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with techniques for transitioning between types of CSI processing.

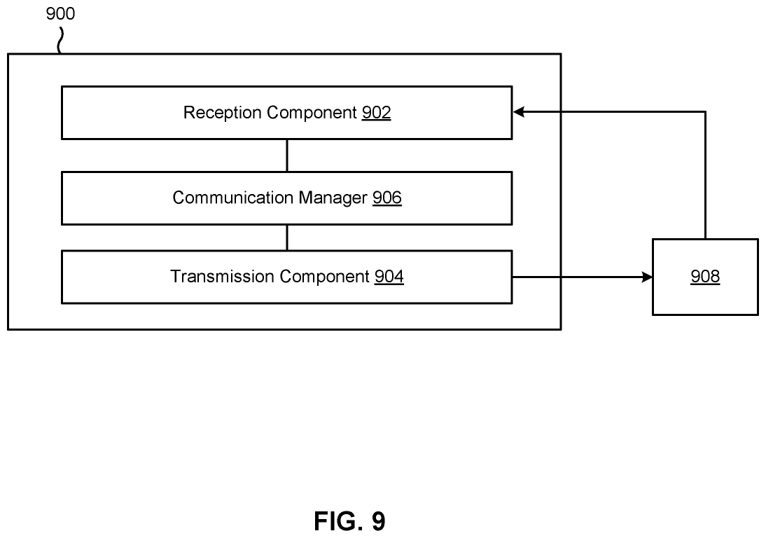

As shown in FIG. 7, in some aspects, process 700 may include receiving signaling indicating a transition from a first type of CSI processing to a second type of CSI processing at the UE, wherein at least one of the first type of CSI processing or the second type of CSI processing is a machine-learning-based CSI processing type (block 710). For example, the UE (e.g., using reception component 902 and/or communication manager 906, depicted in FIG. 9) may receive signaling indicating a transition from a first type of CSI processing to a second type of CSI processing at the UE, wherein at least one of the first type of CSI processing or the second type of CSI processing is a machine-learning-based CSI processing type, as described above.

As further shown in FIG. 7, in some aspects, process 700 may include transitioning from the first type of CSI processing to the second type of CSI processing in accordance with the signaling and a timeline for the transition (block 720). For example, the UE (e.g., using communication manager 906, depicted in FIG. 9) may transition from the first type of CSI processing to the second type of CSI processing in accordance with the signaling and a timeline for the transition, as described above.

Process 700 may include additional aspects, such as any single aspect or any combination of aspects described below and/or in connection with one or more other processes described elsewhere herein.

In a first aspect, the first type of CSI processing comprises the machine-learning-based CSI processing type and the second type of CSI processing comprises a non-machine-learning-based CSI processing type.

In a second aspect, alone or in combination with the first aspect, the first type of CSI processing comprises a first machine-learning-based CSI processing type and the second type of CSI processing comprises a second machine-learning-based CSI processing type.

In a third aspect, alone or in combination with one or more of the first and second aspects, the signaling is based on a transition of a network energy saving state.

In a fourth aspect, alone or in combination with one or more of the first through third aspects, the timeline indicates a length of time between reception of the signaling and the transition.

In a fifth aspect, alone or in combination with one or more of the first through fourth aspects, the length of time comprises a number of symbols after a last symbol of a channel for transmission of an acknowledgement of the signaling.

In a sixth aspect, alone or in combination with one or more of the first through fifth aspects, process 700 includes transmitting the acknowledgement of the signaling on the channel.

In a seventh aspect, alone or in combination with one or more of the first through sixth aspects, the length of time is based at least in part on a subcarrier spacing, wherein the subcarrier spacing is based at least in part on at least one of a subcarrier spacing of a downlink bandwidth part on which the signaling is received, a subcarrier spacing of an uplink bandwidth part associated with an acknowledgement of the signaling, or a specified subcarrier spacing value.

In an eighth aspect, alone or in combination with one or more of the first through seventh aspects, the length of time comprises a number of symbols after a last symbol of a control resource set in which the signaling is received.

In a ninth aspect, alone or in combination with one or more of the first through eighth aspects, the length of time is based at least in part on a subcarrier spacing, wherein the subcarrier spacing is based at least in part on at least one of a subcarrier spacing of a downlink bandwidth part on which the signaling is received, or a specified subcarrier spacing value.

In a tenth aspect, alone or in combination with one or more of the first through ninth aspects, the transitioning from the first type of CSI processing to the second type of CSI processing further comprises transitioning from the first type of CSI processing to the second type of CSI processing in accordance with a validity duration.

In an eleventh aspect, alone or in combination with one or more of the first through tenth aspects, the validity duration starts upon occurrence of the transitioning from the first type of CSI processing to the second type of CSI processing.

In a twelfth aspect, alone or in combination with one or more of the first through eleventh aspects, process 700 includes transmitting a capability indicating a minimum length of the validity duration.

In a thirteenth aspect, alone or in combination with one or more of the first through twelfth aspects, the transitioning from the first type of CSI processing to the second type of CSI processing further comprises transitioning from the first type of CSI processing to the second type of CSI processing until a cancellation, or an indication to transition to a third type of CSI processing, is received.

In a fourteenth aspect, alone or in combination with one or more of the first through thirteenth aspects, the signaling comprises DCI including a field indicating the transition.

In a fifteenth aspect, alone or in combination with one or more of the first through fourteenth aspects, the DCI is group-specific DCI or UE-specific DCI.

In a sixteenth aspect, alone or in combination with one or more of the first through fifteenth aspects, the DCI comprises DCI for paging.

In a seventeenth aspect, alone or in combination with one or more of the first through sixteenth aspects, the DCI is group-specific DCI that is specific to indicating the transition.

In an eighteenth aspect, alone or in combination with one or more of the first through seventeenth aspects, the signaling comprises a physical downlink shared channel transmission containing a paging message.

In a nineteenth aspect, alone or in combination with one or more of the first through eighteenth aspects, process 700 includes transmitting, prior to receiving the signaling, a request to transition from the first type of CSI processing to the second type of CSI processing.

In a twentieth aspect, alone or in combination with one or more of the first through nineteenth aspects, the request comprises at least one of a physical random access channel transmission, a physical uplink control channel transmission, a physical uplink shared channel transmission, or a dedicated physical channel transmission.

In a twenty-first aspect, alone or in combination with one or more of the first through twentieth aspects, the request comprises a physical random access channel transmission on a particular resource or occasion.

In a twenty-second aspect, alone or in combination with one or more of the first through twenty-first aspects, the request comprises a physical random access channel transmission using a particular physical random access channel preamble.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with techniques for transitioning between types of CSI processing.

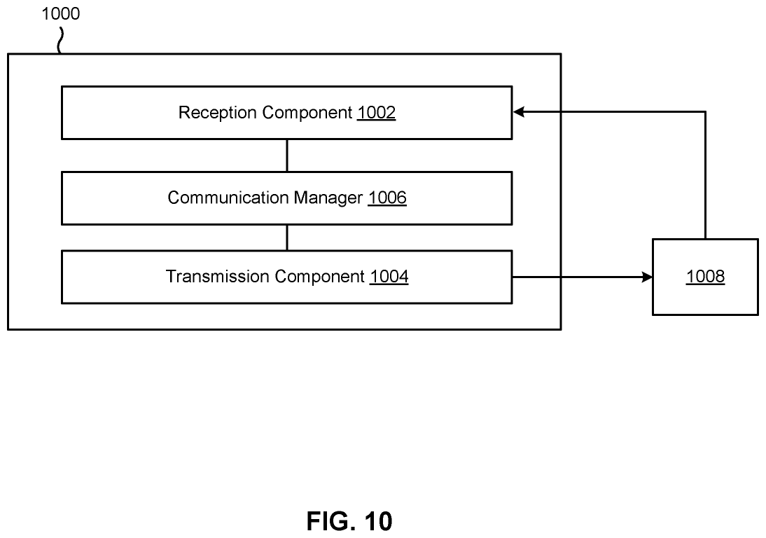

As shown in FIG. 8, in some aspects, process 800 may include transmitting signaling indicating a transition from a first type of CSI processing to a second type of CSI processing at a UE, wherein at least one of the first type of CSI processing or the second type of CSI processing is a machine-learning-based CSI processing type (block 810). For example, the network node (e.g., using transmission component 1004 and/or communication manager 1006, depicted in FIG. 10) may transmit signaling indicating a transition from a first type of CSI processing to a second type of CSI processing at a UE, wherein at least one of the first type of CSI processing or the second type of CSI processing is a machine-learning-based CSI processing type, as described above.

As further shown in FIG. 8, in some aspects, process 800 may include transitioning from the first type of CSI processing to the second type of CSI processing in accordance with the signaling and a timeline for the transition (block 820). For example, the network node (e.g., using communication manager 1006, depicted in FIG. 10) may transition from the first type of CSI processing to the second type of CSI processing in accordance with the signaling and a timeline for the transition, as described above.

Process 800 may include additional aspects, such as any single aspect or any combination of aspects described below and/or in connection with one or more other processes described elsewhere herein.

In a first aspect, the first type of CSI processing comprises the machine-learning-based CSI processing type and the second type of CSI processing comprises a non-machine-learning-based CSI processing type.

In a second aspect, alone or in combination with the first aspect, the first type of CSI processing comprises a first machine-learning-based CSI processing type and the second type of CSI processing comprises a second machine-learning-based CSI processing type.

In a third aspect, alone or in combination with one or more of the first and second aspects, the signaling is based at least in part on a transition of a network energy saving state associated with the network node.

In a fourth aspect, alone or in combination with one or more of the first through third aspects, the timeline indicates a length of time between reception of the signaling and the transition.

In a fifth aspect, alone or in combination with one or more of the first through fourth aspects, the length of time comprises a number of symbols after a last symbol of a channel for transmission of an acknowledgement of the signaling.

In a sixth aspect, alone or in combination with one or more of the first through fifth aspects, process 800 includes receiving the acknowledgement of the signaling on the channel.

In a seventh aspect, alone or in combination with one or more of the first through sixth aspects, the length of time is based at least in part on a subcarrier spacing, wherein the subcarrier spacing is based at least in part on at least one of a subcarrier spacing of a downlink bandwidth part on which the signaling is transmitted, a subcarrier spacing of an uplink bandwidth part associated with an acknowledgement of the signaling, or a specified subcarrier spacing value.

In an eighth aspect, alone or in combination with one or more of the first through seventh aspects, the length of time comprises a number of symbols after a last symbol of a control resource set in which the signaling is transmitted.

In a ninth aspect, alone or in combination with one or more of the first through eighth aspects, the length of time is based at least in part on a subcarrier spacing, wherein the subcarrier spacing is based at least in part on at least one of a subcarrier spacing of a downlink bandwidth part on which the signaling is received, or a specified subcarrier spacing value.

In a tenth aspect, alone or in combination with one or more of the first through ninth aspects, the transitioning from the first type of CSI processing to the second type of CSI processing further comprises transitioning from the first type of CSI processing to the second type of CSI processing in accordance with a validity duration.

In an eleventh aspect, alone or in combination with one or more of the first through tenth aspects, the validity duration starts upon occurrence of the transitioning from the first type of CSI processing to the second type of CSI processing.

In a twelfth aspect, alone or in combination with one or more of the first through eleventh aspects, process 800 includes receiving a capability indicating a minimum length of the validity duration.

In a thirteenth aspect, alone or in combination with one or more of the first through twelfth aspects, the transitioning from the first type of CSI processing to the second type of CSI processing further comprises transitioning from the first type of CSI processing to the second type of CSI processing until a cancellation, or an indication to transition to a third type of CSI processing, is transmitted.

In a fourteenth aspect, alone or in combination with one or more of the first through thirteenth aspects, process 800 includes transmitting the cancellation or the indication.

In a fifteenth aspect, alone or in combination with one or more of the first through fourteenth aspects, the signaling comprises DCI including a field indicating the transition.

In a sixteenth aspect, alone or in combination with one or more of the first through fifteenth aspects, the DCI is group-specific DCI or UE-specific DCI.

In a seventeenth aspect, alone or in combination with one or more of the first through sixteenth aspects, the DCI comprises DCI for paging.

In an eighteenth aspect, alone or in combination with one or more of the first through seventeenth aspects, the signaling comprises a physical downlink shared channel transmission containing a paging message.

In a nineteenth aspect, alone or in combination with one or more of the first through eighteenth aspects, process 800 includes transmitting the signaling in accordance with the request.

In a twentieth aspect, alone or in combination with one or more of the first through nineteenth aspects, the request comprises at least one of a physical random access channel transmission, a physical uplink control channel transmission, a physical uplink shared channel transmission, or a dedicated physical channel transmission.

In a twenty-first aspect, alone or in combination with one or more of the first through twentieth aspects, the request comprises a physical random access channel transmission on a particular resource or occasion.

In a twenty-second aspect, alone or in combination with one or more of the first through twenty-first aspects, the request comprises a physical random access channel transmission using a particular physical random access channel preamble.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 3-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive signaling indicating a transition from a first type of CSI processing to a second type of CSI processing at the UE, wherein at least one of the first type of CSI processing or the second type of CSI processing is a machine-learning-based CSI processing type. The communication manager 906 may transition from the first type of CSI processing to the second type of CSI processing in accordance with the signaling and a timeline for the transition.

The transmission component 904 may transmit the acknowledgement of the signaling on the channel.

The transmission component 904 may transmit a capability indicating a minimum length of the validity duration.

The transmission component 904 may transmit, prior to receiving the signaling, a request to transition from the first type of CSI processing to the second type of CSI processing.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 3-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit signaling indicating a transition from a first type of CSI processing to a second type of CSI processing at a UE, wherein at least one of the first type of CSI processing or the second type of CSI processing is a machine-learning-based CSI processing type. The communication manager 1006 may transition from the first type of CSI processing to the second type of CSI processing in accordance with the signaling and a timeline for the transition.

The reception component 1002 may receive the acknowledgement of the signaling on the channel.

The reception component 1002 may receive a capability indicating a minimum length of the validity duration.

The transmission component 1004 may transmit the cancellation or the indication.

The transmission component 1004 may transmit the signaling in accordance with the request.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving signaling indicating a transition from a first type of channel state information (CSI) processing to a second type of CSI processing at the UE, wherein at least one of the first type of CSI processing or the second type of CSI processing is a machine-learning-based CSI processing type; and transitioning from the first type of CSI processing to the second type of CSI processing in accordance with the signaling and a timeline for the transition.

Aspect 2: The method of Aspect 1, wherein the first type of CSI processing comprises the machine-learning-based CSI processing type and the second type of CSI processing comprises a non-machine-learning-based CSI processing type.

Aspect 3: The method of any of Aspects 1-2, wherein the first type of CSI processing comprises a first machine-learning-based CSI processing type and the second type of CSI processing comprises a second machine-learning-based CSI processing type.

Aspect 4: The method of any of Aspects 1-3, wherein the signaling is based on a transition of a network energy saving state.

Aspect 5: The method of any of Aspects 1-4, wherein the timeline indicates a length of time between reception of the signaling and the transition.

Aspect 6: The method of Aspect 5, wherein the length of time comprises a number of symbols after a last symbol of a channel for transmission of an acknowledgement of the signaling.

Aspect 7: The method of Aspect 6, further comprising transmitting the acknowledgement of the signaling on the channel.

Aspect 8: The method of Aspect 5, wherein the length of time is based at least in part on a subcarrier spacing, wherein the subcarrier spacing is based at least in part on at least one of: a subcarrier spacing of a downlink bandwidth part on which the signaling is received, a subcarrier spacing of an uplink bandwidth part associated with an acknowledgement of the signaling, or a specified subcarrier spacing value.

Aspect 9: The method of Aspect 5, wherein the length of time comprises a number of symbols after a last symbol of a control resource set in which the signaling is received.

Aspect 10: The method of Aspect 9, wherein the length of time is based at least in part on a subcarrier spacing, wherein the subcarrier spacing is based at least in part on at least one of: a subcarrier spacing of a downlink bandwidth part on which the signaling is received, or a specified subcarrier spacing value.

Aspect 11: The method of any of Aspects 1-10, wherein the transitioning from the first type of CSI processing to the second type of CSI processing further comprises transitioning from the first type of CSI processing to the second type of CSI processing in accordance with a validity duration.

Aspect 12: The method of Aspect 11, wherein the validity duration starts upon occurrence of the transitioning from the first type of CSI processing to the second type of CSI processing.

Aspect 13: The method of Aspect 11, further comprising transmitting a capability indicating a minimum length of the validity duration.

Aspect 14: The method of any of Aspects 1-13, wherein the transitioning from the first type of CSI processing to the second type of CSI processing further comprises transitioning from the first type of CSI processing to the second type of CSI processing until a cancellation, or an indication to transition to a third type of CSI processing, is received.

Aspect 15: The method of any of Aspects 1-14, wherein the signaling comprises downlink control information (DCI) including a field indicating the transition.

Aspect 16: The method of Aspect 15, wherein the DCI is group-specific DCI or UE-specific DCI.

Aspect 17: The method of Aspect 15, wherein the DCI comprises DCI for paging.

Aspect 18: The method of Aspect 15, wherein the DCI is group-specific DCI that is specific to indicating the transition.

Aspect 19: The method of any of Aspects 1-18, wherein the signaling comprises a physical downlink shared channel transmission containing a paging message.

Aspect 20: The method of any of Aspects 1-19, further comprising transmitting, prior to receiving the signaling, a request to transition from the first type of CSI processing to the second type of CSI processing.

Aspect 21: The method of Aspect 20, wherein the request comprises at least one of: a physical random access channel transmission, a physical uplink control channel transmission, a physical uplink shared channel transmission, or a dedicated physical channel transmission.

Aspect 22: The method of Aspect 20, wherein the request comprises a physical random access channel transmission on a particular resource or occasion.

Aspect 23: The method of Aspect 20, wherein the request comprises a physical random access channel transmission using a particular physical random access channel preamble.

Aspect 24: A method of wireless communication performed by a network node, comprising: transmitting signaling indicating a transition from a first type of channel state information (CSI) processing to a second type of CSI processing at a user equipment (UE), wherein at least one of the first type of CSI processing or the second type of CSI processing is a machine-learning-based CSI processing type; and transitioning from the first type of CSI processing to the second type of CSI processing in accordance with the signaling and a timeline for the transition.

Aspect 25: The method of Aspect 24, wherein the first type of CSI processing comprises the machine-learning-based CSI processing type and the second type of CSI processing comprises a non-machine-learning-based CSI processing type.

Aspect 26: The method of any of Aspects 24-25, wherein the first type of CSI processing comprises a first machine-learning-based CSI processing type and the second type of CSI processing comprises a second machine-learning-based CSI processing type.

Aspect 27: The method of any of Aspects 24-26, wherein the signaling is based at least in part on a transition of a network energy saving state associated with the network node.

Aspect 28: The method of any of Aspects 24-27, wherein the timeline indicates a length of time between reception of the signaling and the transition.

Aspect 29: The method of Aspect 28, wherein the length of time comprises a number of symbols after a last symbol of a channel for transmission of an acknowledgement of the signaling.

Aspect 30: The method of Aspect 29, further comprising receiving the acknowledgement of the signaling on the channel.

Aspect 31: The method of Aspect 28, wherein the length of time is based at least in part on a subcarrier spacing, wherein the subcarrier spacing is based at least in part on at least one of: a subcarrier spacing of a downlink bandwidth part on which the signaling is transmitted, a subcarrier spacing of an uplink bandwidth part associated with an acknowledgement of the signaling, or a specified subcarrier spacing value.

Aspect 32: The method of Aspect 28, wherein the length of time comprises a number of symbols after a last symbol of a control resource set in which the signaling is transmitted.

Aspect 33: The method of Aspect 32, wherein the length of time is based at least in part on a subcarrier spacing, wherein the subcarrier spacing is based at least in part on at least one of: a subcarrier spacing of a downlink bandwidth part on which the signaling is received, or a specified subcarrier spacing value.

Aspect 34: The method of any of Aspects 24-33, wherein the transitioning from the first type of CSI processing to the second type of CSI processing further comprises transitioning from the first type of CSI processing to the second type of CSI processing in accordance with a validity duration.

Aspect 35: The method of Aspect 34, wherein the validity duration starts upon occurrence of the transitioning from the first type of CSI processing to the second type of CSI processing.

Aspect 36: The method of Aspect 34, further comprising receiving a capability indicating a minimum length of the validity duration.

Aspect 37: The method of any of Aspects 24-36, wherein the transitioning from the first type of CSI processing to the second type of CSI processing further comprises transitioning from the first type of CSI processing to the second type of CSI processing until a cancellation, or an indication to transition to a third type of CSI processing, is transmitted.

Aspect 38: The method of Aspect 37, further comprising transmitting the cancellation or the indication.

Aspect 39: The method of any of Aspects 24-38, wherein the signaling comprises downlink control information (DCI) including a field indicating the transition.

Aspect 40: The method of Aspect 39, wherein the DCI is group-specific DCI or UE-specific DCI.

Aspect 41: The method of Aspect 39, wherein the DCI comprises DCI for paging.

Aspect 42: The method of any of Aspects 24-41, wherein the signaling comprises a physical downlink shared channel transmission containing a paging message.

Aspect 43: The method of any of Aspects 24-42, further comprising receiving, prior to transmitting the signaling, a request to transition from the first type of CSI processing to the second type of CSI processing, wherein transmitting the signaling further comprises transmitting the signaling in accordance with the request.

Aspect 44: The method of Aspect 43, wherein the request comprises at least one of: a physical random access channel transmission, a physical uplink control channel transmission, a physical uplink shared channel transmission, or a dedicated physical channel transmission.

Aspect 45: The method of Aspect 43, wherein the request comprises a physical random access channel transmission on a particular resource or occasion.

Aspect 46: The method of Aspect 43, wherein the request comprises a physical random access channel transmission using a particular physical random access channel preamble.

Aspect 47: An apparatus for wireless communication at a device, comprising a processor; memory coupled with the processor; and instructions stored in the memory and executable by the processor to cause the apparatus to perform the method of one or more of Aspects 1-46.

Aspect 48: A device for wireless communication, comprising a memory and one or more processors coupled to the memory, the one or more processors configured to perform the method of one or more of Aspects 1-46.

Aspect 49: An apparatus for wireless communication, comprising at least one means for performing the method of one or more of Aspects 1-46.

Aspect 50: A non-transitory computer-readable medium storing code for wireless communication, the code comprising instructions executable by a processor to perform the method of one or more of Aspects 1-46.

Aspect 51: A non-transitory computer-readable medium storing a set of instructions for wireless communication, the set of instructions comprising one or more instructions that, when executed by one or more processors of a device, cause the device to perform the method of one or more of Aspects 1-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media May include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors, coupled to the one or more memories, individually or collectively configured to:
receive signaling indicating a transition from a first type of channel state information (CSI) processing to a second type of CSI processing at the UE, wherein at least one of the first type of CSI processing or the second type of CSI processing is a machine-learning-based CSI processing type; and
transition from the first type of CSI processing to the second type of CSI processing in accordance with the signaling and a timeline for the transition.

2. The UE of claim 1, wherein the first type of CSI processing comprises the machine-learning-based CSI processing type and the second type of CSI processing comprises a non-machine-learning-based CSI processing type.

3. The UE of claim 1, wherein the first type of CSI processing comprises a first machine-learning-based CSI processing type and the second type of CSI processing comprises a second machine-learning-based CSI processing type.

4. The UE of claim 1, wherein the signaling is based on a transition of a network energy saving state.

5. The UE of claim 1, wherein the timeline indicates a length of time between reception of the signaling and the transition.

6. The UE of claim 5, wherein the length of time comprises a number of symbols after a last symbol of a channel for transmission of an acknowledgement of the signaling.

7. The UE of claim 5, wherein the length of time is based at least in part on a subcarrier spacing, wherein the subcarrier spacing is based at least in part on at least one of:
a subcarrier spacing of a downlink bandwidth part on which the signaling is received,
a subcarrier spacing of an uplink bandwidth part associated with an acknowledgement of the signaling, or
a specified subcarrier spacing value.

8. The UE of claim 5, wherein the length of time comprises a number of symbols after a last symbol of a control resource set in which the signaling is received.

9. The UE of claim 1, wherein the one or more processors, to transition from the first type of CSI processing to the second type of CSI processing, are individually or collectively configured to transition from the first type of CSI processing to the second type of CSI processing in accordance with a validity duration.

10. The UE of claim 9, wherein the validity duration starts upon occurrence of the transitioning from the first type of CSI processing to the second type of CSI processing.

11. The UE of claim 9, wherein the one or more processors are further individually or collectively configured to transmit a capability indicating a minimum length of the validity duration.

12. The UE of claim 1, wherein the one or more processors, to transition from the first type of CSI processing to the second type of CSI processing, are individually or collectively configured to transition from the first type of CSI processing to the second type of CSI processing until a cancellation, or an indication to transition to a third type of CSI processing, is received.

13. The UE of claim 1, wherein the signaling comprises downlink control information (DCI) including a field indicating the transition.

14. The UE of claim 13, wherein the DCI is group-specific DCI or UE-specific DCI.

15. The UE of claim 13, wherein the DCI comprises DCI for paging.

16. The UE of claim 13, wherein the DCI is group-specific DCI that is specific to indicating the transition.

17. The UE of claim 1, wherein the signaling comprises a physical downlink shared channel transmission containing a paging message.

18. The UE of claim 1, wherein the one or more processors are further individually or collectively configured to transmit, prior to receiving the signaling, a request to transition from the first type of CSI processing to the second type of CSI processing.

19. The UE of claim 18, wherein the request comprises at least one of:
a physical random access channel transmission,
a physical uplink control channel transmission,
a physical uplink shared channel transmission, or
a dedicated physical channel transmission.

20. The UE of claim 18, wherein the request comprises a physical random access channel transmission on a particular resource or occasion.

21. The UE of claim 18, wherein the request comprises a physical random access channel transmission using a particular physical random access channel preamble.

22. A network node for wireless communication, comprising:
one or more memories; and
one or more processors, coupled to the one or more memories, individually or collectively configured to:
transmit signaling indicating a transition from a first type of channel state information (CSI) processing to a second type of CSI processing at a user equipment (UE), wherein at least one of the first type of CSI processing or the second type of CSI processing is a machine-learning-based CSI processing type; and
transition from the first type of CSI processing to the second type of CSI processing in accordance with the signaling and a timeline for the transition.

23. The network node of claim 22, wherein the first type of CSI processing comprises the machine-learning-based CSI processing type and the second type of CSI processing comprises a non-machine-learning-based CSI processing type.

24. The network node of claim 22, wherein the first type of CSI processing comprises a first machine-learning-based CSI processing type and the second type of CSI processing comprises a second machine-learning-based CSI processing type.

25. The network node of claim 22, wherein the signaling is based at least in part on a transition of a network energy saving state associated with the network node.

26. The network node of claim 22, wherein the timeline indicates a length of time between reception of the signaling and the transition.

27. The network node of claim 22, wherein the one or more processors, to transition from the first type of CSI processing to the second type of CSI processing, are individually or collectively configured to transition from the first type of CSI processing to the second type of CSI processing in accordance with a validity duration.

28. The network node of claim 22, wherein the one or more processors are further individually or collectively configured to receive, prior to transmitting the signaling, a request to transition from the first type of CSI processing to the second type of CSI processing, wherein the one or more processors, to transmit the signaling, are further individually or collectively configured to transmit the signaling in accordance with the request.

29. A method of wireless communication performed by a user equipment (UE), comprising:
receiving signaling indicating a transition from a first type of channel state information (CSI) processing to a second type of CSI processing at the UE, wherein at least one of the first type of CSI processing or the second type of CSI processing is a machine-learning-based CSI processing type; and
transitioning from the first type of CSI processing to the second type of CSI processing in accordance with the signaling and a timeline for the transition.

30. A method of wireless communication performed by a network node, comprising:
transmitting signaling indicating a transition from a first type of channel state information (CSI) processing to a second type of CSI processing at a user equipment (UE), wherein at least one of the first type of CSI processing or the second type of CSI processing is a machine-learning-based CSI processing type; and
transitioning from the first type of CSI processing to the second type of CSI processing in accordance with the signaling and a timeline for the transition.
